(19) United States
(12) Patent Application Publication
(10) Pub. No.: US 2006/0051474 A1
(43) Pub. Date: Mar. 9, 2006

(54) Protein-enriched nut butter compositions and methods for preparing same

(76) Inventors: Norman Burr Furlong, Houston, TX (US); Cynthia Lynnelle Furlong, Houston, TX (US)

Correspondence Address: Randall C. Furlong, 2931 Jarrard Street, Houston, TX, 77005-3035, US

(21) Appl. No.: 11/221,560

(22) Filed: Sep. 8, 2005

Related U.S. Application Data
(60) Provisional application No. 60/607,915, filed on Sep. 8, 2004.

(51) Int. Cl. A23B 4/03

(52) U.S. Cl. 426/471

(57) ABSTRACT

A protein-enriched nut butter composition is provided, the protein-enriched nut butter composition comprising a mixture of at least one of finely ground roasted nuts and milled roasted nuts and a substantially unflavored powdered protein preparation, wherein the protein-enriched nut butter composition (1) is up to about 50% enriched in nutritive protein value, (2) remains substantially homogeneously mixed when stored at at least one of about room temperature and about refrigerator temperature, (3) is conveniently spreadable at at least one of about room temperature and about refrigerator temperature, and (4) does not require an addition of at least one of saturated fats and hydrogenated fats to remain substantially homogeneous upon storage. Optionally, the protein-enriched nut butter composition (5) falls within a definition of low carbohydrate products, and (6) is suitable for use in low glycemic index diets comprising at least one of the Atkins Diet, the South Beach Diet, and diets formulated for diabetic patients.

### RELATED APPLICATION

This application claims the benefit of U.S. Provisional Patent Application Ser. No. 60/607,915, filed Sep. 8, 2004, which is herein incorporated by reference in its entirety as if set forth below.

### BACKGROUND OF THE INVENTION

1. Field of the Invention

The present invention pertains to protein-enriched nut butter compositions. More particularly, the present invention pertains to nut butter compositions comprising a continuous nut butter-in-nut oil phase to which is added a powdered protein product and, optionally, other flavoring and/or textural components. The resultant nut butter compositions possess enriched amounts of protein per serving as well as nut butter compositions that remain substantially homogeneous at room temperature and/or refrigerator temperatures. The resultant nut butter compositions are readily spreadable at room and/or refrigerator temperatures. The improved nut butter compositions may be used directly and/or may be incorporated onto, and/or into, edible carriers to provide a wide variety of ingestible and nutritionally-enhanced compositions.

2. Description of the Prior Art

Peanut butter is a cohesive, comminuted mixture of ground peanut particles suspended in liquid peanut oil. Peanut butter is prepared by roasting, blanching and grinding shelled peanuts to form a peanut paste. During the grinding step, the cellular structure of the peanuts is ruptured releasing the peanut oil in which the peanut particles become suspended. These suspensions tend to separate out of the liquid phase unless they are stabilized with high melting point fats or emulsifiers. Other additions to the peanut paste in some commercially available peanut butters include salt, sugar and coarsely ground peanut particles of varying sizes.

The protein content of standard peanut butters is approximately 25% by weight and the fat content makes up about 50% or more of the weight of the peanut paste along with a carbohydrate content of up to about 12% by weight in some commercial brands with added sugar. Animal fats and hydrogenated vegetable fats have been added to commercial peanut butters to prevent oil separation on standing, but these sources increase the amount of nutritionally undesirable saturated fats. The addition of hydrogenated fats also introduces trans-fatty acids to the composition and these have been found to be associated with increased risk of heart and blood vessel disease.

Many supplementary materials have been added to peanut butter ingredients to make peanut sandwich spreads. These supplementary materials include dextrose up to about 10% by weight concentration, partially or completely hydrogenated fats up to about 15% by weight concentration, and also combinations of sugar and fat additives. These added materials have served either to make the product less sticky in eating quality or to make the product stable against oil separation, or to make the product more flavorful. Thus, although these additives serve useful purposes, they also reduce the protein nutritive value of the resulting product since they do not themselves contain protein and rather dilute the protein present in conventional peanut butter. In addition, the addition of sugars and/or other carbohydrates decreases the suitability of these products for diets designed to control levels of circulating insulin. Finally, conventional peanut butters often utilize hydrogenated vegetable oils, which contain the nutritionally undesirable trans-fatty acids.

Izzo and Lieberman in U.S. Pat. No. 5,240,734, incorporated by reference herein, disclose the use of a protein-complexing agent and coagulates of proteins to achieve a homogeneous peanut spread with somewhat reduced fat content.

Darragh and Succo in U.S. Pat. No. 3,580,729 disclose a protein-supplemented peanut spread prepared by the additions of soy flour and liquid vegetable oil, which is then stabilized by heat and cold treatments. The Darragh and Succo product, thus, contains soy flour carbohydrates, more fat than natural peanut butter, and requires stabilizing treatments. Darragh and Succo in U.S. Pat. No. 3,580,729 also disclose a peanut butter containing 15% soy flour. This peanut butter apparently did not contain fat additives, but the soy flour, added to retard oil separation, raised the non-fiber carbohydrate level of the resulting peanut butter product.

Melnick in U.S. Pat. No. 3,216,830 discloses the addition of animal proteins, for example lactalbumin, or nonfat dry milk solids, to peanut butter ingredients to improve the protein nutritive value of a peanut spread. Melnick says that it is essential that animal protein be added rather than vegetable protein. Melnick finds it necessary to add saturated and/or hydrogenated fats at an elevated temperature in order to impart to the resulting spread an eating quality equivalent to conventional peanut butter.

Lilien and Olabe in U.S. Pat. No. 3,037,865 disclose the addition of defatted wheat germ, a vegetable material, to peanut butter. However, their defatted wheat germ consists of over 50% carbohydrates, making their peanut butter unsuitable for low carbohydrate and/or diabetic formulations, according to at least one definition of low carbohydrate products.

### SUMMARY OF THE INVENTION

The present invention is directed to a protein-enriched nut butter composition and methods for preparing the same that overcome, or at least minimize, some of the drawbacks of the conventional peanut butter compositions described above.

A protein-enriched nut butter composition is provided, the protein-enriched nut butter composition comprising a mixture of at least one of finely ground roasted nuts and milled roasted nuts and a substantially unflavored powdered protein preparation, wherein the protein-enriched nut butter composition (1) is up to about 50% enriched in nutritive protein value, (2) remains substantially homogeneously mixed when stored at at least one of about room temperature and about refrigerator temperature, (3) is conveniently spreadable at at least one of about room temperature and about refrigerator temperature, and (4) does not require an addition of at least one of saturated fats and hydrogenated fats to remain substantially homogeneous upon storage. Optionally, the protein-enriched nut butter composition (5) falls within a definition of low carbohydrate products, and (6) is suitable for use in low glycemic index diets comprising at least one of the Atkins Diet, the South Beach Diet, and diets formulated for diabetic patients.

It is an object of the present invention to provide a nut spread containing added protein in a form that provides a nut butter-like eating quality, color, and flavor, and a protein nutritional value higher than that of conventional nut butter. The nut spread of the present invention differs from the spreads described in the Izzo and Lieberman, Darragh and Succo, Melnick, Lilien et al. patents in that the additional protein may be added in a non-denatured form resulting in a superior stable and/or spreadable product without further additives and/or special processing treatments, and resulting in compositions suitable for low carbohydrate diets without the health hazards posed by saturated fats and/or trans-fatty acids.

It has been discovered that a protein-enriched nut spread that resists separation on standing, is spreadable over a wide range of temperatures, and results in a convenient and nutritious food product with up to about 50% more protein with no increase in carbohydrate or fat may be prepared by the thorough mixing of natural nut butter with soy, whey and/or other suitable protein powders. It has also been discovered that the variety and palatability of such a protein-enriched nut spread may be adjusted to individual tastes by the addition of at least one sweetener, coarsely ground peanuts (and/or other types of nuts), table salt, low sodium salt, a salt substitute, fruit concentrates and/or other flavoring agents.

### DETAILED DESCRIPTION OF ILLUSTRATIVE EMBODIMENTS OF THE PRESENT INVENTION

Illustrative embodiments of the invention are described in detail below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Although the protein content of peanut butter provides a significant nutritional benefit, some nutritionists conclude that this benefit is offset by the high saturated fat and trans-fat content of these compositions. However, recent nutritional research has indicated that mono-unsaturated, non-hydrogenated fats, such as those found in natural peanut butter (that is, a peanut butter prepared directly from roasted peanuts without admixture of other hydrogenated or non-hydrogenated vegetable oils and/or other adulterants), may actually confer health benefits for diets in which the digestible carbohydrate ingested is low enough to prevent insulin over-secretion.

The ingredients used in one of the simpler illustrative embodiments of a product composition according to the present invention comprise a peanut butter produced either by processing fresh roasted peanuts in a machine (such as the Salton Model PB-2 Peanut Butter Maker) or by using a commercial peanut butter (such as All Natural Laura Scudders Old Fashioned Peanut Butter) to which is added a protein powder (such as Now Sports Soy Protein), at about room temperature in a single-stage mixing process. These components are mixed in approximate proportions of peanut butter to protein powder of about ten to one (by weight) or, equivalently, of about eight to three (by volume). For example, about one pound (454 g) of peanut butter may be mixed with about 0.1 pounds (45 g) of protein powder, which amounts to about one and a third cups of peanut butter to about a half cup of protein powder. The two components may be thoroughly mixed at about room temperature in a single-stage mixing process, either mechanically and/or manually, and may form a stable paste, which may be spread either at about room temperature and/or about refrigerator temperature.

Other illustrative embodiments comprise adjustments to the tastes and/or textures of the paste, prepared as described above, such as the mixing in of at least one artificial sweetener, for example, about one or more tablespoons of Splenda (or about one teaspoon of Sweet and Low) for a sweeter product, and/or the inclusion of about a third or about a half cup of coarsely ground roasted nuts (for variety in taste and/or for additional protein) and/or the inclusion of about a generous half cup of a fruit preserve preparation, such as Polaner Sugar Free Apricot Preserves, and the like, for a combined peanut butter/jelly product. For example, the inclusion of about a third or about a half cup of coarsely ground fresh roasted peanuts and the inclusion of about a generous half-cup of Welch's Grape Jelly may produce an exemplary crunchy peanut butter/jelly product, in formulations not restricted to those of controlled carbohydrate content.

In various illustrative embodiments, a protein-enriched nut butter composition may comprise a mixture of finely ground roasted nuts and/or milled roasted nuts comprising one or more of peanuts, pecans, walnuts, cashews, almonds, pistachios, hazelnuts, and/or macadamia nuts, and a substantially unflavored powdered protein preparation. In various illustrative embodiments, the substantially unflavored powdered protein preparation may be such that the natural flavor of the protein-enriched nut butter composition may not be masked by another flavor. In various illustrative embodiments, the protein-enriched nut butter composition (1) may be up to about 50% enriched in nutritive protein value, (2) may remain substantially homogeneously mixed when stored at either about room temperature or about refrigerator temperature, (3) may be conveniently spreadable at at either about room temperature or about refrigerator temperature, and (4) does not require an addition of saturated fats and/or hydrogenated fats to remain substantially homogeneous upon storage. In various illustrative embodiments, the protein-enriched nut butter composition may optionally (5) fall within a definition of low carbohydrate products, and (6) be suitable for use in low glycemic index diets comprising at least one of the Atkins Diet, the South Beach Diet, and diets formulated for diabetic patients. In various illustrative embodiments, the protein-enriched nut butter composition may remain substantially homogeneously mixed when stored at either about room temperature or about refrigerator temperature when the phases of the protein-enriched nut butter composition resist separation upon standing.

In various illustrative embodiments, varieties of chunky protein-enriched nut butter compositions may comprise an addition of coarsely chopped and/or crumbled peanuts, pecans, walnuts, cashews, almonds, pistachios, hazelnuts, and/or macadamia nuts. In various illustrative embodiments, the protein-enriched nut butter composition may have a desired sweetness level that may be adjusted by an addition of at least one artificial sweetener. In such embodiments, the protein-enriched nut butter composition (5) may fall within a definition of low carbohydrate products, and (6) may be suitable for use in low glycemic index diets comprising at least one of the Atkins Diet, the South Beach Diet, and diets formulated for diabetic patients.

In various alternative illustrative embodiments, the protein-enriched nut butter composition may have a desired sweetness level that may be adjusted by an addition of at least one source of natural sugars, including, but not limited to, honey, corn syrup, refined sucrose, molasses, and the like, in formulations not restricted to those of controlled carbohydrate content. In various illustrative embodiments, the protein-enriched nut butter composition may have a salt other than sodium chloride and/or a salt substitute is added, with an advantage to those on low salt diets that many distinctive and unpleasant tastes associated with salts other than sodium chloride may be acceptably masked by a natural flavor of the protein-enriched nut butter composition.

In various illustrative embodiments, protein-enriched nut butter and jelly combinations acceptable to low carbohydrate diets may be prepared in a stable composition by an admixture of suitable flavored fruit spreads. In such embodiments, the protein-enriched nut butter composition (5) may fall within a definition of low carbohydrate products, and (6) may be suitable for use in low glycemic index diets comprising at least one of the Atkins Diet, the South Beach Diet, and diets formulated for diabetic patients. In various alternative illustrative embodiments, protein-enriched nut butter and jelly combinations may be prepared in a stable composition by an admixture of ordinary fruit spreads in formulations not restricted to those of controlled carbohydrate content.

In various illustrative embodiments, a protein-enriched peanut butter composition may comprise a mixture of finely ground roasted peanuts and/or milled roasted peanuts, and a substantially unflavored powdered protein preparation. In various illustrative embodiments, the substantially unflavored powdered protein preparation may be such that the natural flavor of the protein-enriched peanut butter composition may not be masked by another flavor. In various illustrative embodiments, the protein-enriched peanut butter composition (1) may be up to about 50% enriched in nutritive protein value, (2) may remain substantially homogeneously mixed when stored at either about room temperature or about refrigerator temperature, (3) may be conveniently spreadable at at either about room temperature or about refrigerator temperature, and (4) does not require an addition of saturated fats and/or hydrogenated fats to remain substantially homogeneous upon storage. In various illustrative embodiments, the protein-enriched peanut butter composition may optionally (5) fall within a definition of low carbohydrate products, and (6) be suitable for use in low glycemic index diets comprising at least one of the Atkins Diet, the South Beach Diet, and diets formulated for diabetic patients. In various illustrative embodiments, the protein-enriched peanut butter composition may remain substantially homogeneously mixed when stored at either about room temperature or about refrigerator temperature when the phases of the protein-enriched peanut butter composition resist separation upon standing.

In various illustrative embodiments, varieties of chunky protein-enriched peanut butter compositions may comprise an addition of coarsely chopped and/or crumbled peanuts, pecans, walnuts, cashews, almonds, pistachios, hazelnuts, and/or macadamia nuts. In various illustrative embodiments, the protein-enriched peanut butter composition may have a desired sweetness level that may be adjusted by an addition of at least one artificial sweetener. In such embodiments, the protein-enriched peanut butter composition (5) may fall within a definition of low carbohydrate products, and (6) may be suitable for use in low glycemic index diets comprising at least one of the Atkins Diet, the South Beach Diet, and diets formulated for diabetic patients.

In various alternative illustrative embodiments, the protein-enriched peanut butter composition may have a desired sweetness level that may be adjusted by an addition of at least one source of natural sugars in formulations not restricted to those of controlled carbohydrate content. In various illustrative embodiments, the protein-enriched peanut butter composition may have a salt other than sodium chloride and/or a salt substitute is added, with an advantage to those on low salt diets that many distinctive and unpleasant tastes associated with salts other than sodium chloride may be acceptably masked by a natural flavor of the protein-enriched peanut butter composition.

In various illustrative embodiments, protein-enriched peanut butter and jelly combinations acceptable to low carbohydrate diets may be prepared in a stable composition by an admixture of suitable flavored fruit spreads. In such embodiments, the protein-enriched peanut butter composition (5) may fall within a definition of low carbohydrate products, and (6) may be suitable for use in low glycemic index diets comprising at least one of the Atkins Diet, the South Beach Diet, and diets formulated for diabetic patients. In various alternative illustrative embodiments, protein-enriched peanut butter and jelly combinations may be prepared in a stable composition by an admixture of ordinary fruit spreads in formulations not restricted to those of controlled carbohydrate content.

In various illustrative embodiments, a peanut butter spread with enhanced nutritive value may be provided, having a composition that has a high protein-to-carbohydrate ratio, that does not separate after standing at room temperature and/or refrigerator temperature, and that possesses good spreadability at either room or refrigerator temperatures. The peanut butter spread may be prepared by manual or mechanical mixing of a protein preparation with natural peanut butter (that is, a peanut butter prepared directly from roasted peanuts without admixture of other hydrogenated or non-hydrogenated vegetable oils or other adulterants). The present disclosure also includes various illustrative embodiments of those compositions resulting from processing the peanut butter spread with enhanced nutritive value further by the addition of other components such as coarsely ground peanuts, sugar substitutes, additional salt and/or other flavoring agents. These compositions are formulated to provide a highly nutritious, low carbohydrate spread that does not contain elevated amounts of saturated fats or transfatty acids.

The present invention is well adapted to carry out the objects and attain the ends and advantages mentioned, as well as those that are inherent therein. While the invention has been depicted, described and is defined by reference to exemplary embodiments of the invention, such a reference does not imply a limitation of the invention, and no such limitation is to be inferred. The invention is capable of considerable modification, alteration, and equivalency in form and function as will occur to those of ordinary skill in the pertinent arts having the benefit of this disclosure. The depicted and described embodiments of the invention are exemplary only and are not exhaustive of the scope of the invention. Consequently, the invention is intended to be limited only by the spirit and scope of the appended claims, giving full cognizance to equivalents in all respects.

The particular embodiments disclosed above are illustrative only, as the invention may be modified and practiced in different but equivalent manners apparent to those skilled in the art having the benefit of the teachings herein. Furthermore, no limitations are intended to the details of composition or design herein shown, other than as described in the claims below. It is therefore evident that the particular embodiments disclosed above may be altered or modified and all such variations are considered within the scope and spirit of the invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, in the sense of Georg Cantor. Accordingly, the protection sought herein is as set forth in the claims below.

The embodiments of the present invention described herein are merely exemplary and are not intended to limit the scope of this invention. Many variations and modifications may be made without departing from the spirit and scope of the invention. Applicants intend that all such modifications and variations are to be included within the scope of the invention as defined in the appended claims and their equivalents.

We claim:

1. A protein-enriched nut butter composition comprising:
a mixture of at least one of finely ground roasted nuts and milled roasted nuts comprising at least one of peanuts, pecans, walnuts, cashews, almonds, pistachios, hazelnuts, and macadamia nuts; and
a substantially unflavored powdered protein preparation,
wherein the protein-enriched nut butter composition (1) is up to about 50% enriched in nutritive protein value, (2) remains substantially homogeneously mixed when stored at at least one of about room temperature and about refrigerator temperature, (3) is conveniently spreadable at at least one of about room temperature and about refrigerator temperature, and (4) does not require an addition of at least one of saturated fats and hydrogenated fats to remain substantially homogeneous upon storage.

2. The protein-enriched nut butter composition of claim 1,
wherein varieties of chunky protein-enriched nut butter compositions comprise an addition of at least one of coarsely chopped and crumbled at least one of peanuts, pecans, walnuts, cashews, almonds, pistachios, hazelnuts, and macadamia nuts.

3. The protein-enriched nut butter composition of claim 1,
wherein a desired sweetness level is adjusted by an addition of at least one artificial sweetener.

4. The protein-enriched nut butter composition of claim 3,
wherein the protein-enriched nut butter composition (5) falls within a definition of low carbohydrate products, and (6) is suitable for use in low glycemic index diets comprising at least one of the Atkins Diet, the South Beach Diet, and diets formulated for diabetic patients.

5. The protein-enriched nut butter composition of claim 1,
wherein a desired sweetness level is adjusted by an addition of at least one source of natural sugars in formulations not restricted to those of controlled carbohydrate content.

6. The protein-enriched nut butter composition of claim 1,
wherein at least one of a salt other than sodium chloride and a salt substitute is added with an advantage to those on low salt diets that many distinctive and unpleasant tastes associated with salts other than sodium chloride are acceptably masked by a natural flavor of the protein-enriched nut butter composition.

7. The protein-enriched nut butter composition of claim 1,
wherein nut butter and jelly combinations acceptable to low carbohydrate diets are prepared in a stable composition by an admixture of suitable flavored fruit spreads.

8. The protein-enriched nut butter composition of claim 7,
wherein the protein-enriched nut butter composition (5) falls within a definition of low carbohydrate products, and (6) is suitable for use in low glycemic index diets comprising at least one of the Atkins Diet, the South Beach Diet, and diets formulated for diabetic patients.

9. The protein-enriched nut butter composition of claim 1,
wherein nut butter and jelly combinations are prepared in a stable composition by an admixture of ordinary fruit spreads in formulations not restricted to those of controlled carbohydrate content.

10. A protein-enriched nut butter composition comprising:
a mixture of at least one of finely ground roasted nuts and milled roasted nuts comprising at least one of peanuts, pecans, walnuts, cashews, almonds, pistachios, hazelnuts, and macadamia nuts; and
a substantially unflavored powdered protein preparation,
wherein the protein-enriched nut butter composition (1) is up to about 50% enriched in nutritive protein value, (2) remains substantially homogeneously mixed when stored at at least one of about room temperature and about refrigerator temperature, (3) is conveniently spreadable at at least one of about room temperature and about refrigerator temperature, (4) does not require an addition of at least one of saturated fats and hydrogenated fats to remain substantially homogeneous upon storage, (5) falls within a definition of low carbohydrate products, and (6) is capable of being produced at about room temperature in a single-stage mixing process.

11. A protein-enriched peanut butter composition capable of being produced at about room temperature in a single-stage mixing process, the protein-enriched peanut butter composition comprising:
a mixture of at least one of finely ground roasted peanuts and milled roasted peanuts; and
a substantially unflavored powdered protein preparation,
wherein the protein-enriched peanut butter composition (1) is up to about 50% enriched in nutritive protein value, (2) remains substantially homogeneously mixed when stored at at least one of about room temperature and about refrigerator temperature, (3) is conveniently spreadable at at least one of about room temperature and about refrigerator temperature, and (4) does not require an addition of at least one of saturated fats and hydrogenated fats to remain substantially homogeneous upon storage.

12. The protein-enriched peanut butter composition of claim 11,
wherein varieties of chunky protein-enriched peanut butter compositions comprise an addition of at least one of coarsely chopped and crumbled at least one of peanuts, pecans, walnuts, cashews, almonds, pistachios, hazelnuts, and macadamia nuts.

13. The protein-enriched peanut butter composition of claim 11,
wherein a desired sweetness level is adjusted by an addition of at least one artificial sweetener.

14. The protein-enriched peanut butter composition of claim 13,
wherein the protein-enriched peanut butter composition (5) falls within a definition of low carbohydrate products, and (6) is suitable for use in low glycemic index diets comprising at least one of the Atkins Diet, the South Beach Diet, and diets formulated for diabetic patients.

15. The protein-enriched peanut butter composition of claim 11,
wherein a desired sweetness level is adjusted by an addition of at least one source of natural sugars in formulations not restricted to those of controlled carbohydrate content.

16. The protein-enriched peanut butter composition of claim 11,
wherein at least one of a salt other than sodium chloride and a salt substitute is added with an advantage to those on low salt diets that many distinctive and unpleasant tastes associated with salts other than sodium chloride are acceptably masked by a natural flavor of the protein-enriched peanut butter composition.

17. The protein-enriched peanut butter composition of claim 11,
wherein peanut butter and jelly combinations acceptable to low carbohydrate diets are prepared in a stable composition by an admixture of suitable flavored fruit spreads.

18. The protein-enriched peanut butter composition of claim 17,
wherein the protein-enriched peanut butter composition (5) falls within a definition of low carbohydrate products, and (6) is suitable for use in low glycemic index diets comprising at least one of the Atkins Diet, the South Beach Diet, and diets formulated for diabetic patients.

19. The protein-enriched peanut butter composition of claim 11,
wherein peanut butter and jelly combinations are prepared in a stable composition by an admixture of ordinary fruit spreads in formulations not restricted to those of controlled carbohydrate content.

20. The protein-enriched peanut butter composition of claim 11,
wherein the protein-enriched peanut butter composition (5) falls within a definition of low carbohydrate products, and (6) is suitable for use in low glycemic index diets comprising at least one of the Atkins Diet, the South Beach Diet, and diets formulated for diabetic patients.
